(19) United States
(12) Patent Application Publication
(10) Pub. No.: US 2010/0071159 A1
(43) Pub. Date: Mar. 25, 2010

(54) HINGE TYPE COVER OPENING AND CLOSING DEVICE FOR MOBILE PHONE

(75) Inventor: Ho-Sik Myung, Chungcheongnam-do (KR)

Correspondence Address: SCHWEGMAN, LUNDBERG & WOESSNER, P.A., P.O. BOX 2938, MINNEAPOLIS, MN, 55402, US

(73) Assignee: Prexco Co., Ltd, Chungcheongnam-do (KR)

(21) Appl. No.: 12/526,750

(22) PCT Filed: Dec. 24, 2007
(86) PCT No.: PCT/KR2007/006795

§ 371 Date: Aug. 11, 2009

(30) Foreign Application Priority Data
Feb. 14, 2007 (KR) 20-2007-0002620

(51) Int. Cl. E05F 1/08

(52) U.S. Cl. 16/303

(57) ABSTRACT

A hinge-type cover opening/closing device is designed to smoothly open and close a cover by preventing sudden rotation of the cover. The hinge-type cover opening/closing device for a mobile device includes a pair of hinge shafts, a pair of guide members that are fixedly installed on the hinge shafts, spaced apart from each other by a predetermined distance in a length direction of the hinge shaft, and that enable the hinge shafts to rotate about each other, and one or more cam actuating units that are installed on the hinge shafts, spaced apart from each other by a predetermined distance in the length direction, and that enable the hinge shafts to rotate about each other within a predetermined angle range.

### TECHNICAL FIELD

The present invention relates to a hinge-type cover opening/closing device for a mobile device. More particularly, the present invention relates to a hinge-type cover opening/closing device for a mobile device, which is designed to reduce a thickness of the mobile device and to prevent sudden rotation of a cover during opening/closing operation of the cover.

### BACKGROUND ART

Generally, mobile devices such as mobile phones, personal digital assistants (PDAs), laptop computers, digital multimedia broadcasting terminals, and the like use mobile broadcasting and communication services while on the move.

The mobile devices serve as major essential items that allow a user to enjoy daily living in the information age. Particularly, mobile phones have been widely used regardless of age, from elementary school students to the elderly.

Different types of cover opening/closing devices have been used for the mobile devices. For example, the cover opening/closing devices may be classified into hinge-type devices, sliding-type devices, swing-type devices, and the like.

Particularly, the hinge-type cover opening/closing devices have been widely used for the mobile devices as they can be manufactured through a simple process and are durable.

FIG. 1 exemplarily shows a mobile device having a typical hinge-type cover opening/closing device. The mobile device includes a main body 3 and a cover 6. The main body 3 includes a key input unit 4 and a microphone 5, and the cover 6 includes a display unit 7 and a speaker 8.

The cover 6 and the main body 3 are interconnected by a hinge-type cover opening/closing device 10.

As shown in FIGS. 2 and 3, the hinge-type cover opening/closing device 10 includes an outer case 11 having an opened end, a stationary cam 12 having a first end that is assembled in the outer case 11 to be capable of rotating, a movable cam 14 that is disposed in the outer case 11 to be capable of moving in a length direction, an elastic member 16 for biasing the movable cam 14 toward the stationary cam 12, and a hinge shaft 18 that rotatably assembles and supports the outer case 11 and the stationary cam 12.

The outer case 11 is inserted in a hole 6b formed through an upper assembling member 6a formed on a lower end of the cover 6. The stationary cam 12 is inserted in a hole 3b formed through a lower assembling member 3a formed on both sides of the upper end of the main body 3.

As shown in FIG. 4, cam surfaces 13 and 15 having a cam shape having upward slopes and downward slopes are respectively formed on facing surfaces of the stationary and movable cams 12 and 14.

### Technical Object

Since the above-described typical hinge-type cover opening/closing device for the mobile device is designed such that the upper and lower assembling members are respectively formed on the cover and the main body, the thickness of the mobile device is increased.

Therefore, it is difficult to reduce the thickness and size of the mobile device and to refine a design of the mobile device.

In addition, the hinge-type cover opening/closing device is not good in terms of outer appearance as compared with the swing-type cover opening/closing device and the slide-type cover opening/closing device.

Further, since the upper and lower assembling members are formed in a protruding structure, they may be easily cracked. Particularly, when the mobile device is designed in a slim structure, the strength of the upper and lower assembling members may be further weakened.

Furthermore, since the typical hinge-type cover opening/closing device for the mobile device is designed such that the cover suddenly rotates in a predetermined rotational section and stops after colliding with the main body, impact may be applied to a case and other components of the mobile device.

Therefore, the components may be damaged and thus the service life of the mobile device is reduced. Additionally, impact noise is generated.

Accordingly, as the mobile devices are gradually increased in size due to the diversification of functions thereof, there is a need for a cover opening/closing device that can stably open and close the cover and satisfy the slimness and refined design and that is durable.

Therefore, the present invention has been made to meet the above need. It is an object of the present invention to provide a hinge-type cover opening/closing device for a mobile device, which is designed such that components thereof are installed to be exposed to an external side and thus there is no need to form a space or structure for installing the components on a main body or cover, thereby making it easy to reduce the thickness and size of the mobile device and refine the design thereof.

It is another object of the present invention to provide a hinge-type opening/closing device for a mobile device, which is configured to control a rotational speed of the cover, thereby preventing sudden rotation and sudden stop of the cover.

It is still another object of the present invention to provide a hinge-type opening/closing device that is appropriate for a relatively heavy and large mobile device by arranging components thereof such that the cover can be stably and securely opened and closed.

### Technical Solution

A hinge-type cover opening/closing device for a mobile device in accordance with the present invention includes a pair of hinge shafts, a pair of guide members that are fixedly installed on the hinge shafts, spaced apart from each other by a predetermined distance in a length direction of the hinge shaft, and that enable the hinge shafts to rotate about each other, and one or more cam actuating units that are installed on the hinge shafts, spaced apart from each other by a predetermined distance in the length direction, and that enable the hinge shafts to rotate about each other within a predetermined angle range.

The cam actuation unit includes one or more rotational cams that are integrally and rotatably formed with at least one of the guide members, one or more one movable cams that are installed on the hinge shafts and spaced apart from each other by a predetermined distance to be capable of moving in the length direction and closely contacting the rotational cams, and one or more elastic members biasing the movable cams to the rotational cams.

Each of the hinge shafts may be divided into left and right hinge shafts spaced apart from each other by a predetermined distance in the length direction, and facing first ends of the left and right hinge shafts are rotatably connected to the connecting member.

The guide members are gears having centers respectively fixed to the hinge shafts.

The elastic members are compression coil springs that are spirally wound around the outer circumferences of the respective hinge shafts. The hinge-type cover opening/closing device may further include a pair of stationary members for fixing the hinge shafts to a main body and the cover of the mobile device. The hinge-type cover opening/closing device may further include a case member enclosing the guide members and the cam actuation units at predetermined intervals.

### ADVANTAGEOUS EFFECT

According to the hinge-type opening/closing device for the mobile device in accordance with the present invention, since there is no need to form the upper and lower assembling members that have been formed on the main body and the cover of the typical hinge-type cover opening/closing device, it is easy to reduce the thickness and size of the mobile device and to refine the design thereof. In addition, since portions that are weak in strength can be eliminated, the service life of the mobile device can increase. Further, like the slide-type cover opening/closing device and the swing-type cover opening/closing device, the hinge-type cover opening/closing device of the present invention can provide an excellent outer appearance for the mobile device.

According to the hinge-type opening/closing device for the mobile device in accordance with the present invention, since the hinge shafts rotate about each other by the gears engaged with each other, the opening/closing speed of the mobile device is retarded and remains constant.

Therefore, the opening/closing operation of the cover can be smoothly and naturally realized and the impact generated during the opening/closing operation can be reduced. Therefore, user convenience can be improved and the service life of the mobile device can increase. In addition, since the collision between the cover and the main body is not strong, the noise generated by the collision can be reduced.

According to the hinge-type opening/closing device for the mobile device in accordance with the present invention, the guide members are installed on opposite ends of the hinge shafts and the cam actuation units are symmetrically installed. In addition, each of the hinge shafts is divided into left and right hinge shafts. Therefore, even when the hinge-type opening/closing device is applied to a relatively heavy and large mobile device such as a laptop computer, a digital multimedia broadcasting terminal, a personal multimedia player, a navigation aid, a portable television, and the like, the opening/closing operation of the cover can be smoothly and stably realized while providing a durable structure.

According to the hinge-type opening/closing device for the mobile device in accordance with the present invention, since the cover is designed to rotate by up to 360°, the user convenience can be dramatically improved. For example, a user can see a screen of the mobile device without opening the cover.

### BRIEF DESCRIPTION OF DRAWINGS

FIG. 1 is a perspective view of a mobile device having a typical hinge-type cover opening/closing device.

FIG. 2 is an exploded perspective view of a typical cover opening/closing device for a mobile device.

FIG. 3 is a cross-sectional view of a typical cover opening/closing device for a mobile device.

FIG. 4 is a cam diagram of movable and rotational cams of a typical cover opening/closing device for a mobile device.

FIG. 5 is a perspective view of a hinge-type cover opening/closing device for a mobile device according to an exemplary embodiment of the present invention.

FIG. 6 is a front view of a hinge-type cover opening/closing device for a mobile device according to an exemplary embodiment of the present invention.

FIG. 7 is a side view of a hinge-type cover opening/closing device for a mobile device according to an exemplary embodiment of the present invention.

FIG. 8 is a front view illustrating use of a hinge-type cover opening/closing device for a mobile device according to an exemplary embodiment of the present invention.

FIG. 9 is a side view illustrating use of a hinge-type cover opening/closing device for a mobile device according to an exemplary embodiment of the present invention.

FIG. 10 is a perspective view of rotational and movable cams of a hinge-type cover opening/closing device for a mobile device according to an exemplary embodiment of the present invention.

FIG. 11 is a cross-sectional view of a cam actuation unit of a hinge-type cover opening/closing device for a mobile device according to an exemplary embodiment of the present invention.

FIG. 12 is a perspective view of a hooking member and a stopper of a hinge-type cover opening/closing device for a mobile device according to an exemplary embodiment of the present invention.

FIG. 13 is a side view of a hooking member and a stopper of a hinge-type cover opening/closing device for a mobile device according to an exemplary embodiment of the present invention.

FIG. 14 is an exploded perspective view of a case member of a hooking member and a stopper of a hinge-type cover opening/closing device for a mobile device according to an exemplary embodiment of the present invention.

FIG. 15 is a side view illustrating an operational state of a cam actuation unit of a hinge-type cover opening/closing device for a mobile device according to an exemplary embodiment of the present invention.

FIG. 16 is a front view illustrating an operational state of a cam actuation unit of a hinge-type cover opening/closing device for a mobile device according to an exemplary embodiment of the present invention.

FIG. 17 is a cam diagram illustrating an operational state of a cam actuation unit of a hinge-type cover opening/closing device for a mobile device according to an exemplary embodiment of the present invention.

FIG. 18 is a perspective view of a hinge-type cover opening/closing device for a mobile device according to a second exemplary embodiment of the present invention.

FIG. 19 is a cross-sectional view of a hinge-type cover opening/closing device for a mobile device according to a second exemplary embodiment of the present invention.

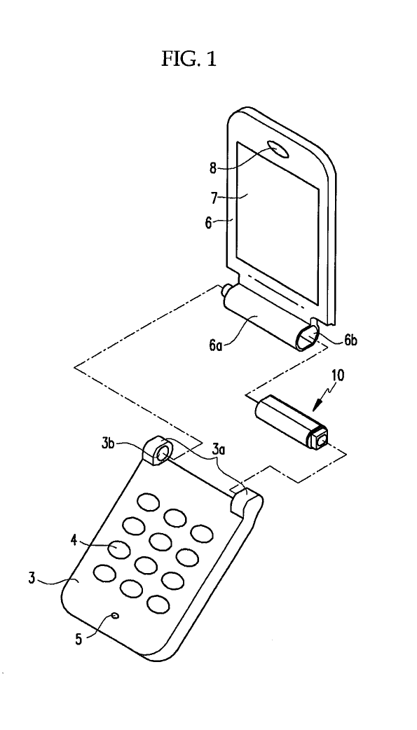

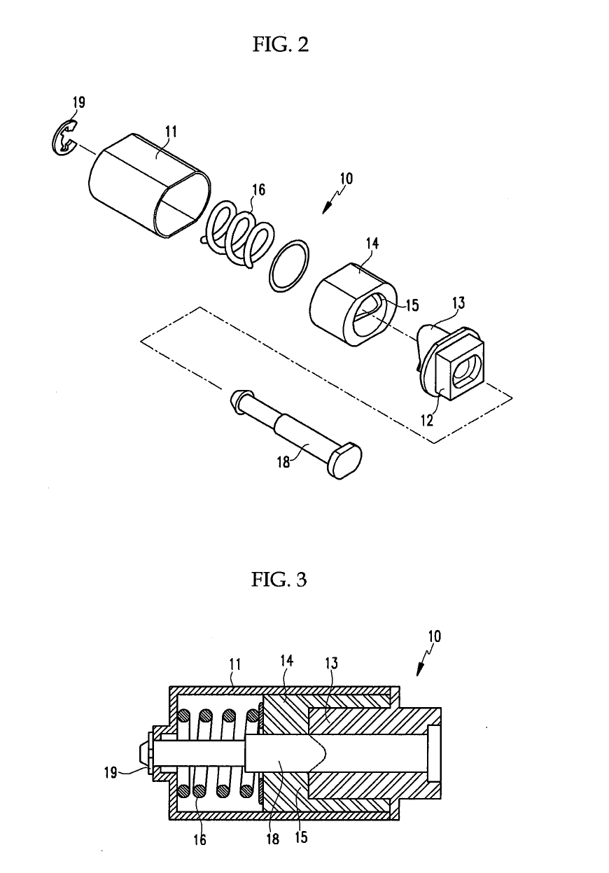

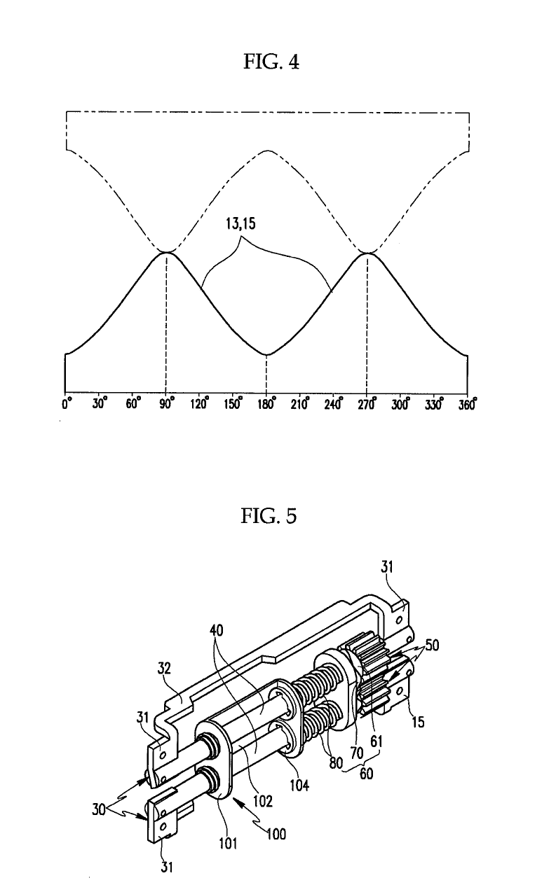

### BEST MODE

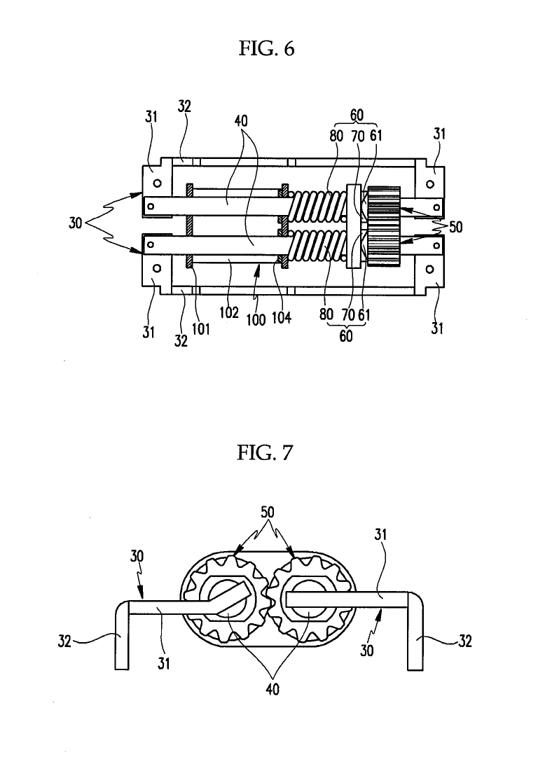

As shown in FIGS. 5 through 7, a hinge-type cover opening/closing device in accordance with an exemplary embodiment of the present invention includes a pair of stationary members 30, a pair of hinge shafts 40 fixedly connected to the stationary members 3, respectively, a pair of guide members 50 enabling the hinge shafts to rotate about each other, and a cam actuating unit 60 enabling the hinge shafts 40 to rotate about each other within a predetermined rotational angle range.

The stationary members 30 are formed in an approximate [symbol] -shape.

That is, each of the stationary members 30 includes a pair of hinge connecting portions 31 spaced apart from each other by a predetermined distance, and a stationary portion 32 connected to first ends of the hinge connecting portions 31 to form a [symbol] -shape together with the hinge connecting portions 31.

The second ends of the hinge connecting portions 31 are vertically connected to opposite ends of the corresponding hinge shaft 40.

The hinge connecting portions 31 of at least one of the stationary members 30 may be formed in a V-shape when viewed from a side.

The stationary portions 32 of at least one of the stationary members 30 may be formed to be bent at right angles to the first ends of the hinge connecting portions 32 when viewed from a side.

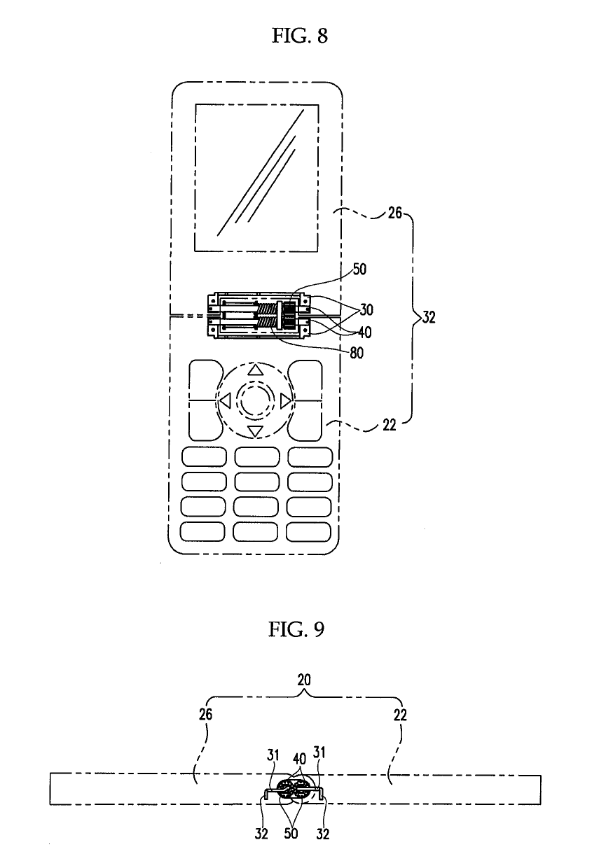

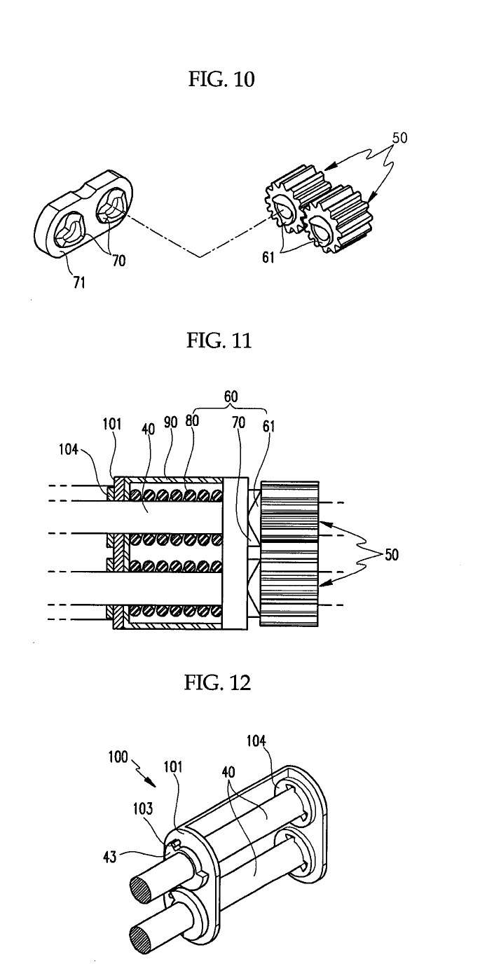

As shown in FIGS. 8 and 9, one of the stationary members 30 is fixed to a main body 22 of a mobile device 20, and the other is fixed to a cover 26 of the mobile device 20.

The hinge shafts 40 are formed of a material having excellent strength, such as metal. The hinge shafts 40 are formed in an elongated bar shape.

The guide members 50 are formed as gears 50 having centers that are respectively fixed to the hinge shafts 40.

The guide members 50 are formed of a metal or a synthetic resin. The guide members 50 may be integrally formed with the hinge shafts 40. Alternatively, the guide members 50 may be separately formed and assembled with the hinge shafts 40.

The cam actuation unit 60 includes a pair of rotational cams 61 that are integrally and rotatably formed with the respective hinge shafts 40, at least one movable cam 70 that is installed on the hinge shafts 40 to be capable of moving in the length direction of the hinge shafts 40 and that closely contacts the rotational cams 61, at least one elastic member 80 for biasing the movable cam 70 toward the rotational cams 61, and a supporting member 100 that is disposed between the movable cam 70 and the elastic member 80 to support the biasing force of the elastic member 80.

The rotational cams 61 are formed on first end surfaces of the respective guide members 50 in a gear-teeth-shape along outer circumferences of the hinge shafts 40.

The movable cams 70 are formed on a first end surface of a movable body 71 that is movably installed on the hinge shafts 40. The movable cams 70 are formed in a gear-teeth-shape along the circumferences of the hinge shafts 40.

The rotational cams 61 and the movable cams 70 may be formed in well-known structures used in typical mobile devices.

In the present exemplary embodiment, a pair of the rotational cams 61 and a pair of the movable cams 70 are installed. However, the present invention is not limited to the present exemplary embodiment. That is, only one rotational cam and only one movable cam may be installed.

The elastic members 80 may be compression coil springs that are spirally wound around the outer circumferences of the respective hinge shafts 40.

The supporting member 100 is formed in an approximate [symbol] -shape.

That is, the supporting member 100 includes a pair of horizontal portions 101 that are spaced apart from each other by a predetermined distance along the length of the hinge shafts 40 and are provided with holes through which the hinge shafts 40 pass, and a vertical portion 102 connected to first ends of the horizontal portions 101 to form a [symbol] -shape together with the horizontal portions 101.

The elastic members 80 are disposed between one of the horizontal portions of the supporting member 100 and the movable cams 70.

A pair of supporting rings 104 may be respectively installed on the hinge shafts 40 so that the supporting member 100 is not pushed rearward by the biasing force of the elastic members 80 but is fixed at a predetermined location.

The supporting rings 104 are formed as E-shaped metal rings (E-rings).

As shown in FIG. 11, the cam actuating unit 60 may further include an outer case 90 for protecting the movable cams 70 and the elastic member 80 by enclosing the same.

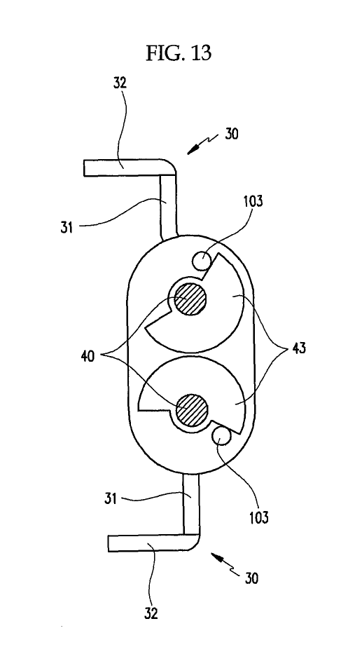

In the hinge-type cover opening/closing device of the mobile device in accordance with the present exemplary embodiment, as shown in FIGS. 12 and 13, a pair of hooking members 43 formed in a fan-shape may be formed on the outer circumferences of the respective hinge shafts 40. In addition, a pair of stoppers 103 may be formed on one of the horizontal portions 101. Each of the stoppers 103 is located between opposite ends of each of the hooking members 43.

When the hooking members 43 and the stoppers 103 are formed as described above, a rotational angle range of the hinge shafts 40 is limited within a predetermined range. The rotational angle range defines an opening angle range of the mobile device 20.

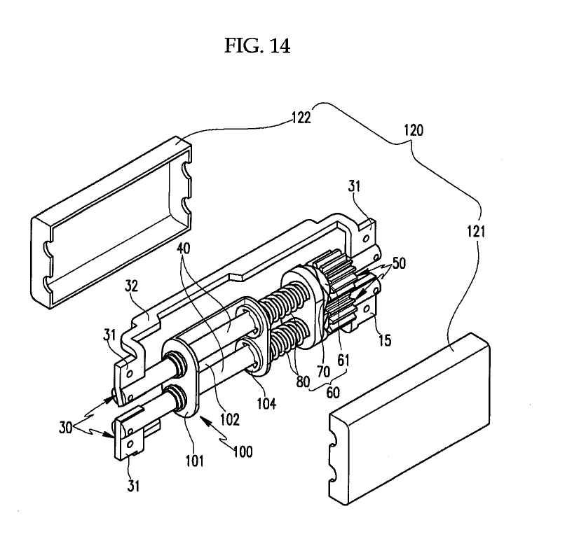

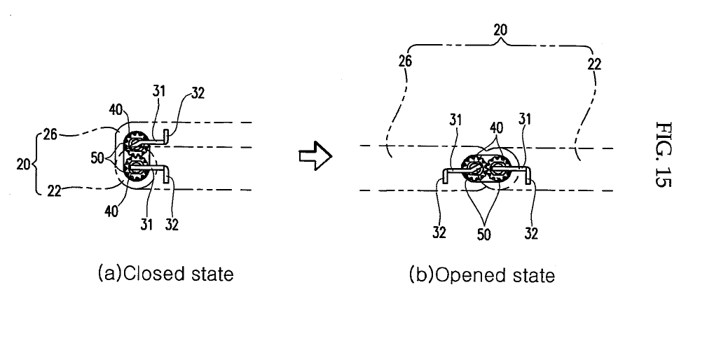

As shown in FIG. 14, the hinge-type cover opening/closing device of the mobile device in accordance with the present exemplary embodiment may further include a case member 120 that encloses the guide members 50 and the cam actuating unit 60 at predetermined intervals.

The case member 120 includes a first case member 121 and a second case member 122 that are designed to be assembled with each other in use.

Although not shown in the drawings, in the hinge-type cover opening/closing device of the mobile device in accordance with the present exemplary embodiment, two pairs of the guide members 50 may be installed on opposite ends of the hinge shafts 40, and a pair of the cam actuating units 60 may be symmetrically installed on both sides of the hinge shafts 40.

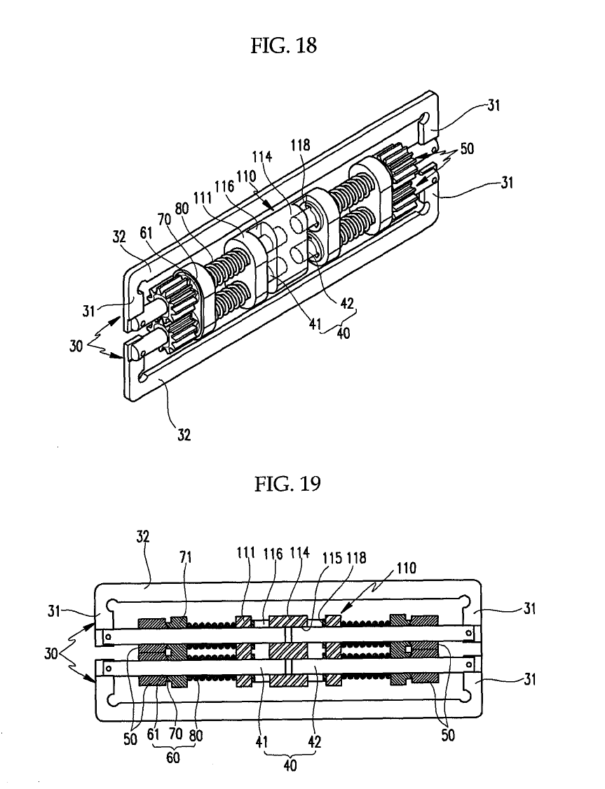

According to another exemplary embodiment of the present invention, as shown in FIGS. 18 and 19, each of the hinge shafts 40 may be divided into left and right hinges shafts 41 and 42 that are rotatably connected to a supporting member. In addition, two pairs of guide members 50 are fixedly installed on the left hinge shafts 41 and the right hinge shafts 42, respectively. A pair of cam actuation units 60 are symmetrically installed on the left and right hinge shafts 41 and 42.

The left hinge shaft 41 is spaced apart from the right hinge shaft 42 in a length direction, and facing first ends of the left and right hinge shafts 41 and 42 are rotatably connected to the supporting member 110.

Second ends of the left and right hinge shafts 41 and 42 are respectively fixed to the hinge connecting portions 31 of the stationary members 30.

The supporting member 110 includes a pair of horizontal portions 111 that are spaced apart from each other by a predetermined distance along the length of the hinge shafts 40 and are provided with holes through which the left and right hinge shafts 41 and 42 pass, a horizontal supporting portion 114 that is formed between the horizontal portions 111 and is provided with insertion holes 115 in which the facing first ends of the left and right hinge shafts 41 and 42 are inserted, and a vertical portion 116 connected to first ends of the horizontal portions 111 to form an E-shape together with the horizontal portions 111 and the horizontal supporting portion 114.

A pair of supporting rings 118 may be respectively inserted around the left and right hinge shafts 41 and 42 to maintain a coupling state of the left and right hinge shafts 41 and 42 to the horizontal portions 111.

Since other components of the present exemplary embodiment are the same as those of the foregoing exemplary embodiment, a detailed description thereof will be omitted herein.

The following will describe an operation of the hinge-type cover opening/closing device of the mobile device in accordance with the present invention with reference to the accompanying drawings.

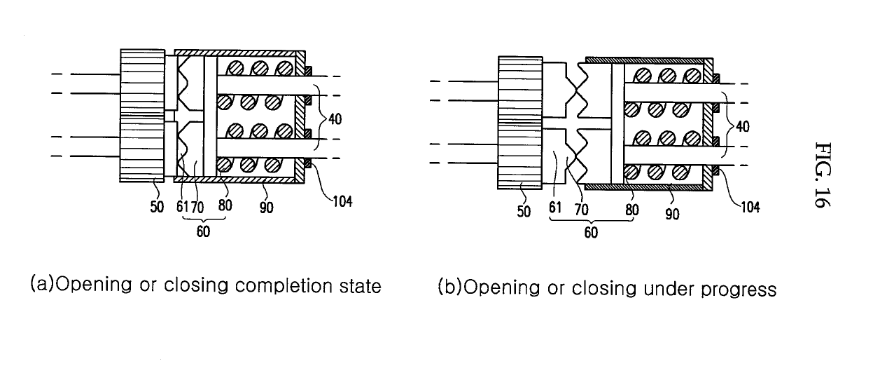

First, in order to open the cover 26 of the mobile device 20, the cover 26 rotates counterclockwise (see FIG. 15).

When the cover 26 rotates counterclockwise, the stationary members 30 fixed on the cover 26 and the hinge shafts 40 rotate together. Therefore, the guide members 50 installed on the hinge shafts 40 are engaged with each other and rotate together.

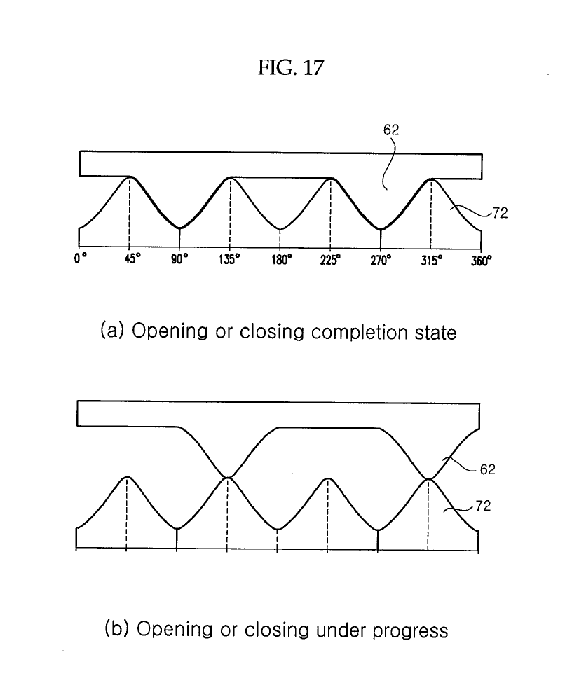

As the guide member 50 rotates, the rotational and movable cams 61 and 70 are engaged with each other but are misaligned with each other. Therefore, the movable body 71 moves away from the rotational cam 61 while overcoming the biasing force of the elastic member 80 (see FIGS. 16 and 17).

When the cover 26 further rotates counterclockwise, the rotational and movable cams 61 and 70 are disengaged from each other and the guide members 50, hinge shafts 40, and stationary members 30 automatically rotate, thereby opening the cover 26.

In order to close the cover 26, the process for opening the cover 26 is identically applied except that the cover 26, the stationary members 30, the hinge shafts 40, and the guide members 50 rotate counterclockwise.

While this invention has been described in connection with what is presently considered to be practical exemplary embodiments of the hinge-type cover opening/closing device, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The hinge-type cover opening/closing device of the present invention may be applied to a mobile phone, a laptop computer, a personal digital assistant, an electronic organizer, a portable game player, and other folder-type electronic devices.

1. A hinge-type cover opening/closing device for a mobile device, the hinge-type cover opening device comprising a pair of hinge shafts, at least a pair of guide members that are fixedly installed on the hinge shafts, spaced apart from each other by a predetermined distance in a length direction of the hinge shaft, and that enable the hinge shafts to rotate about each other, and one or more cam actuating units that are installed on the hinge shafts, spaced apart from each other by a predetermined distance in the length direction, and that enable the hinge shafts to rotate about each other within a predetermined angle range,
wherein the cam actuation unit comprises one or more rotational cams that are integrally and rotatably formed with at least one of the guide members, one or more one movable cams that are installed on the hinge shafts and spaced apart from each other by a predetermined distance to be capable of moving in the length direction and closely contact the rotational cams, and one or more elastic members biasing the movable cams to the rotational cams.

2. The hinge-type cover opening/closing device of claim 1, wherein two pairs of the guide members are respectively installed on opposite ends of the hinge shafts.

3. The hinge-type cover opening/closing device of claim 1, wherein a pair of the cam actuation units are symmetrically installed on opposite ends of the hinge shafts.

4. The hinge-type cover opening/closing device of claim 1, further comprising a supporting member that is disposed between the movable cam of the cam actuation unit and the elastic member to support elastic force of the elastic member,
wherein the supporting member includes a pair of horizontal portions that are spaced apart from each other by a predetermined distance along the length of the hinge shafts and are provided with holes through which the hinge shafts pass, and a vertical portion connected to first ends of the horizontal portions to form a [symbol] -shape together with the horizontal portions,
wherein a pair of hooking members are formed in a fan-shape on outer circumferences of the respective hinge shafts, and
wherein a pair of stoppers are formed on one of the horizontal portions such that each of the stoppers is located between opposite ends of each of the hooking members.

5. The hinge-type cover opening/closing device of claim 1, further comprising a case member that encloses the guide member and the cam actuation unit at predetermined intervals.

6. The extruder of claim 5, wherein a vent ring support is formed at one side portion of the poppet, and a connecting hole communicating the molten plastic pathway with the second plastic moving groove is formed at the vent ring support.

7. The hinge-type cover opening/closing device of claim 1, wherein the guide members are gears having centers respectively fixed to the hinge shafts, and the elastic members are compression coil springs that are spirally wound around the outer circumferences of the respective hinge shafts.

8. The hinge-type cover opening/closing device of claim 1, further comprising a supporting member that is disposed between the movable cam of the cam actuation unit and the elastic member to support elastic force of the elastic member, wherein each of the hinge shafts is divided into left and right hinge shafts spaced apart from each other by a predetermined distance in the length direction and facing ends of the left and right hinge shafts are rotatably connected to the connecting member,
wherein each of the hinge shafts is divided into left and right hinge shafts spaced apart from each other by a predetermined distance in the length direction and facing first ends of the left and right hinge shafts are rotatably connected to the connecting member,
wherein two pairs of the guide members are fixedly installed on the left and right hinge shafts, and
wherein a pair of the cam actuation units are symmetrically installed on the left and right hinge shafts.

9. The hinge-type cover opening/closing device of claim 8, further comprising a case member enclosing the guide members and the cam actuation units at predetermined intervals.

10. The hinge-type cover opening/closing device of claim 8, further comprising a pair of stationary members to which second ends of the left and right hinge shafts are fixedly connected and that fix the left and right hinge shafts to a main body and the cover of the mobile device.

11. The hinge-type cover opening/closing device of claim 8, wherein each of the stationary members includes a pair of hinge connecting portions spaced apart from each other by a predetermined distance, and a stationary portion connected to first ends of the hinge connecting portions to form a ⊂-shape together with the hinge connecting portions.

12. The hinge-type cover opening/closing device of claim 8, wherein the connecting member comprises a pair of horizontal portions that are spaced apart from each other by a predetermined distance along the length of the hinge shafts and are provided with holes through which the left and right hinge shafts pass, a horizontal supporting portion that is formed between the horizontal portions and is provided with insertion holes in which the facing first ends of the left and right hinge shafts are inserted, and a vertical portion connected to first ends of the horizontal portions to form an E-shape together with the horizontal portions and the horizontal supporting portion.

13. The hinge-type cover opening/closing device of claim 12, further comprising a pair of supporting rings that are respectively installed on the hinge shafts to maintain a coupling state of the left and right hinge shafts to the horizontal portions.

14. The hinge-type cover opening/closing device of claim 12, wherein a pair of hooking members are formed on one of outer circumferential surfaces of the left hinge shafts or the right hinge shafts, and
a pair of stoppers are formed on one of the horizontal portions such that each of the stoppers is located between opposite ends of each of the hooking members.

15. The hinge-type cover opening/closing device of claim 8, wherein the guide members are gears having centers respectively fixed to the left and right hinge shafts, and
the elastic members are compression coil springs that are spirally wound around the outer circumferences of the left and right hinge shafts.
